(19) United States
(12) Patent Application Publication
(10) Pub. No.: US 2002/0133578 A1
(43) Pub. Date: Sep. 19, 2002

(54) Novel method in serving residential broadband subscribers

(76) Inventor: C. T. Wu, Santa Clara, CA (US)

Correspondence Address: Supreme Patent Service, P.O. Box 3318, Saratoga, CA, 95070, US

(21) Appl. No.: 09/811,263

(22) Filed: Mar. 17, 2001

Related U.S. Application Data
(60) Provisional application No. 60/262,966, filed on Jan. 18, 2001.

(51) Int. Cl. G06F 15/177; G06F 15/173; G06F 15/16

(52) U.S. Cl. 709/222; 709/223; 709/245

(57) ABSTRACT

A method of serving residential broadband subscribers includes establishing a client-server mechanism between the network device of a residential user and a network device manufacturer or an Internet service provider. The network device is provided with a unique identifier. The dynamic IP addresses assigned to the network device are automatically reported and updated to a web server of the device manufacturer or the service provider. The network device can be located and probed according to the identifier and the IP addresses. To facilitate the diagnosis of network devices attached to a residential gateway/router behind the firewall formed by the gateway/router, a protocol is also defined to report and update the network configuration to the web server. The private network configuration behind the firewall is recorded and analyzed for troubleshooting the residential network.

### FIELD OF THE INVENTION

The present invention generally relates to a residential broadband Internet service, and more specifically to a method of diagnosing network devices in a residential broadband subscriber's network.

### BACKGROUND OF THE INVENTION

In the past, residential users usually use a dial up Modem to connect their CPEs to an ISP when they want to access Internet. Recently new access technology such as Cable Modems or xDSL Modems can provide an Internet service to residential broadband subscribers via existing CATV cables or telephone lines. There are 2 million broadband subscribers in North America in 1999. The number of broadband subscribers grows to 6.6 millions in 2000. It is estimated that there will be 35 million subscribers in North America in 2005. Because the market is growing so rapidly, the speed of broadband installation and its customer service have already become the bottleneck in Broadband deployment.

When a dial up Modem is used to access Internet, users can easily diagnose the failure in the connection for the dial up Modem by detecting whether there is a dial tone provided by a central office. It is quite easy for users to tell whether the failure in connecting to Internet is related to a telephone line or their own CPEs. The diagnosis algorithm is not only simple but also very effective. After the introduction of Cable Modems and xDSL Modems, the dial tone detection algorithm can no longer be applied any more.

Many broadband service issues have been encountered in the industry. There is a strong shortage of competent technicians in servicing the customers because most technicians do not have previous experience in computer or network related skills. There are million demands for the new subscribers. The technicians can not be hired or trained in time to meet the customers' requirement or the business growth. There is also a shortage in competent customer service staffs to respond to different kinds of questions from many different customers.

Furthermore, because of the lack of a diagnostic tool, it is difficult to tell whether the failure is caused by the Cable/Telephone line, the Cable/XDSL Modem, or the residential subscriber's CPEs. The service cost increases significantly from having to pay for the 800 toll free phone bill and sending the technician to the subscriber's home for the troubleshooting. As a result, the residential broadband subscribers complain about the poor service. The broadband Internet service providers can not rapidly deploy their services to increase the popularity and make money to justify their investment because of the high service cost.

There exists another issue in the broadband Internet service in that the ownership of broadband connection is unclear to the broadband subscribers. For example, Yahoo (or America On Line) is a very large ISP. However, Yahoo does not own any of the end to end infrastructure, i.e., the central office equipment, the telephone line (or CATV Cable), or the Cable/XDSL Modem. It is very difficult for an ISP like Yahoo to guarantee Internet service for its customers if there is any failure within the network because the ISP does not own the end to end connectivity. Some ISPs like Kimo.com.tw or yam.com.tw only lease lines from a telephone company without any network diagnosis capability.

Several approaches to resolving the broadband Internet service issues have been used by the service providers. In general, broadband Internet service providers and CPE vendors provide customer technical support by telephone. The support usually involves a direct dialog between the customer and a technical support staff to identify the possible causes of a problem. It works sometimes but is not always an ideal solution.

Two major problems exist for this type of service approach. First, most of the residential broadband Internet service subscribers are not technically knowledgeable about CPE and broadband Internet services and thus can not provide valid troubleshooting and diagnostics feedback to assist the CPE vendor's technical support staff over the phone. Secondly, it is rather cost-prohibitive for CPE vendors to rely on this approach alone to solve subscriber's problems as the profit margins of CPE devices are mostly lower than the cost associated with phone-based technical support.

SNMP/RMON network management protocol, which was created primarily for enterprise LAN/WAN environments, has been part of the prior art to facilitate remote diagnostics and trouble-shooting. However, SNMP/RMON can only remotely diagnose Cable/XDSL Modems because they are directly connected to a broadband service provider's broadband equipment. If the connection failure is caused by the residential broadband subscribers' internal network, neither SNMP nor RMON is capable of diagnosing the root cause of the failure.

SNMP/RMON network management protocol compliant methods as suggested by the prior art have two major pitfalls when applied to the residential broadband Internet scenarios. First of all, the prior art technology related to the SNMP/RMON network management protocol was driven from the perspective of enterprise networking where there is a centralized network management station responsible for overseeing all enterprise LAN/WAN networking devices based on the SNMP/RMON protocol. However, in the residential broadband Internet service environment there are several interconnected network segments (e.g., Cable/DSL access service providers, ISPs, etc.) under different ownership's and different network management functions.

As an example, SeedNET in Taiwan provides ADSL broadband service via Chuan-Hua Telecom's existing telephone line and equipment. SeedNet has no capability in diagnosing Chuan Hua Telecom's network. It will also be difficult for SeedNet to guarantee the broadband service.

Another major problem is that network LAN/WAN entities associated with SNMP/RMON are addressed with their respective IP addresses. But in the residential broadband Internet service environment the IP addresses are generally dynamically assigned through the DHCP protocol standard defined by IETF and thus it is not feasible for the CPE vendors to perform remote diagnostics and troubleshooting based on the prior art method associated with SNMP/RMON.

For example, a CPE is connected in a user's private network for Internet connection. If there is a failure in a broadband network, the user might think that it is a failure of the CPE instead of the network itself. Because the IP address of the CPE is changed frequently, it is also difficult for a CPE manufacturer to find its CPE device located at a broadband subscriber's home via Internet for the remote diagnosis.

In the remote diagnosis of CPE devices used by the residential users, another difficulty exists because of the popularity of residential gateway/router devices. A residential gateway/router device allows several residential users to share one dynamic IP address. It uses network address translation (NAT) to translate one public IP address assigned by an ISP to multiple private IP addresses for multiple residential users in both directions.

The gateway/router device also acts like a firewall to divide the network into two domains. One is the public domain. The gateway/router at the public domain can be accessed via the public IP address assigned by the ISP. The other is the private domain. The network devices connected to the gateway/router such as hubs, switches, and network adapters on PCs can be accessed via the IP addresses assigned by the gateway/router's DHCP server. Because of the nature of NAT, a CPE trouble-shooter has no knowledge about the IP address assigned by a gateway/router's DHCP server. Therefore, the network devices behind a NAT firewall can not be remotely diagnosed.

### SUMMARY OF THE INVENTION

This invention has been made to overcome the above mentioned drawbacks and difficulties of trouble-shooting and diagnosing a broadband subscriber's service problem. The primary object of this invention is to provide a client-server mechanism between a residential network device and a network device manufacturer or an ISP. By means of the client-server mechanism, the dynamic IP address assigned to a network device can be reported and updated for locating and diagnosing the device.

Accordingly, a network device is built in with a unique identifier. When the network device is operating properly in a broadband network and assigned with a dynamic IP address, the network device automatically notify a web server of the device vendor or an ISP of its unique identifier together with its current IP address in use. A plurality of latest historical IP addresses associated with the network device are stored in the data base of the web server. The historical IP addresses are used for locating, identifying and authenticating the network device when remote diagnosis is performed.

It is also an object of the invention to provide a method for remotely diagnosing network devices attached to a residential gateway/router behind the firewall formed by the gateway/router. According to the invention, a client-server mechanism between the gateway/router and a web server is established. A protocol or novel scheme is defined in such a way that the network configuration attached to the gateway/router is reported and updated to the web server as long as the gateway/router is operating properly. When there is a problem in the residential network, the gateway/router can be remotely probed and diagnosed first. The network devices attached in the residential network can then be diagnosed based on unique commands designed to determine the cause of the problem according to the configuration data.

The foregoing and other objects, features, aspects and advantages of the present invention will become better understood from a careful reading of a detailed description provided herein below with appropriate reference to the accompanying drawings.

### DETAILED DESCRIPTION OF THE INVENTION

This invention proposes an end-to-end method to provide an intelligent solution to enable a CPE vendor or an ISP to perform CPE remote diagnostics and troubleshooting. A client-server mechanism is established between a CPE and the CPE vendor or the ISP to allow the client (CPE) to automatically report its IP address assigned by the broadband service provider to the web server of a CPE vendor or an ISP.

According to this invention, a network CPE device is built in with a unique MAC identifier. As long as the network CPE is operating properly under the broadband network, it automatically notifies the web server about its MAC ID together with its current IP address in use when the CPE gets its dynamic IP address from an ISP. Whenever the dynamic IP address of the network CPE is changed, the CPE also keeps updating the web server so that the web server can keep track of the CPE's recent IP addresses.

Once the web server receives a CPE's MAC ID together with its latest IP address, it stores these data into a data base and responds to the CPE as confirmation of receiving the data. The web server keeps the most updated ten IP addresses for each specific CPE with its unique MAC ID. As long as the CPE is operating properly in Internet, the web server can find this CPE by its latest IP address and use the unique MAC ID with its historical IP addresses such as the last ten addresses for authentication. As soon as the CPE can be located, a hand shake protocol can be defined for remote diagnosing the CPE.

Accordingly, with this client-server mechanism a CPE manufacturer or an ISP can remotely diagnose its CPE via Internet even though the CPE manufacturer or the ISP does not own or control the access network. The client-server mechanism for remote diagnosis can be applied to different types of network adapters used in desktop computers and notebook computers such as ethernet network adapters, home PNA network adapters, USB-ethernet network adapters, and wireless LAN adapters.

As pointed out in the background of the invention, because of the nature of NAT, a CPE trouble-shooter has no knowledge about the IP address assigned by a gateway/router's DHCP server. Although a residential gateway/router can be equipped with the above client-server mechanism so that it can be remotely diagnosed, the CPE devices behind the NAT firewall formed by the residential gateway/router in the network still can not be diagnosed remotely via Internet.

To overcome this difficulty, the invention provides a method for reporting the configuration of network devices connected to a residential gateway/router to a web server to enable the remote diagnosis of network devices behind the firewall. A protocol or a novel scheme is defined to report and update the network configuration of CPE LAN devices attached to the gateway/router as long as it is operating properly in Internet. The private LAN's configuration can thus be reported to the web server. The configuration data can be recorded by the web server for the technical support staff to analyze these data and remotely diagnose the residential network.

Assuming there is a problem related to subscriber's broadband service and the broadband end-to-end (from the central office equipment to the subscriber's Cable/XDSL Modem) service is fine, then the problem is most likely associated with either the CPE Router, LAN or the computing devices. Based on the client-server mechanism of this invention, the CPE vendor can initiate a remote CPE router probe according to the CPE router's historical IP addresses to first check whether there is valid IP connection. If the router is OK then the attached LAN and computing devices can be probed via the router according to the network configuration previously being reported to the vendor. A CPE vendor can define commands unique to its network products and broadband server application for determining the causes of the problem.

With the present invention, a CPE manufacturer or an ISP can remotely diagnose a residential network even if it does not own or control the Internet 5 infrastructure. A better service can be provided and because the cost associated with the service is also greatly reduced.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for remotely diagnosing a network problem in a residential network, comprising the steps of:
providing a unique identifier to a network device in said residential network;
reporting and updating Internet address information dynamically assigned to said network device together with said unique identifier to a web server through Internet;
locating said network device using said Internet address information and said identifier; and
probing said network device to remotely trouble shoot said network problem through Internet.

2. The method according to claim 1, wherein said Internet address information comprises at least one most recent IP address dynamically assigned to said network device.

3. The method according to claim 1, wherein said Internet address information comprises a plurality of most recent IP addresses dynamically assigned to said network device.

4. The method according to claim 1, wherein said Internet address information comprises ten most recent IP addresses dynamically assigned to said network device.

5. The method according to claim 1, wherein said network device is a residential gateway/router attached with a private network having a plurality of private network devices, and said method further comprises the steps of:
defining a protocol for reporting network configuration of said private network from said residential gateway/router to said web server through Internet, said network configuration including private network addresses of said private network devices;
reporting and updating said network configuration to said web server; and
probing a private network device in said private network according to the private network address associated with said private network device to remotely trouble shoot said network problem through Internet.

6. The method according to claim 5, wherein unique commands are designed to determine problems associated with said private network devices and probing a private network device is accomplished by issuing an appropriate command associated with the probed private network device.
